(19) United States
(12) Patent Application Publication
(10) Pub. No.: US 2019/0139214 A1
(43) Pub. Date: May 9, 2019

(54) INTERFEROMETRIC DOMAIN NEURAL NETWORK SYSTEM FOR OPTICAL COHERENCE TOMOGRAPHY

(71) Applicant: SIGHTLINE INNOVATION INC., Toronto (CA)

(72) Inventors: Wallace TRENHOLM, Toronto (CA); Lorenzo PONS, Toronto (CA); Mark ALEXIUK, Winnipeg (CA); Hieu DANG, Winnipeg (CA); Siavash MALEKTAJI, Winnipeg (CA); Kamal DARCHINIMARAGHEH, Winnipeg (CA)

(21) Appl. No.: 16/006,043

(22) Filed: Jun. 12, 2018

Related U.S. Application Data
(60) Provisional application No. 62/518,256, filed on Jun. 12, 2017.

(51) Int. Cl. G06T 7/00; G06N 3/04; G06N 3/08; G06T 7/73

(52) U.S. Cl. CPC G06T 7/0004; G06N 3/0445; G06N 3/084; G06T 7/73; G06T 7/62; G06T 2207/20076; G06T 2207/20084; G06T 2207/20081; G06T 2207/10101

(57) ABSTRACT

A method and system for analysis of interferometric domain optical coherence tomography (OCT) data of an object. The method includes: receiving the OCT data comprising one or more A-scans; successively analyzing each of the one or more A-scans, using a trained feed-forward neural network, to detect one or more features associated with the object by associating A-scan raw data with a descriptor for each of the one or more features, the feed-forward neural network trained using previous A-scans with one or more known features; generating location data associated with the one or more features for localizing the one or more features in the one or more A-scans; and outputting the feature detection and the location data.

### TECHNICAL FIELD

The following relates generally to imaging interpretation and more specifically to an interferometric domain neural network system for non-destructive optical coherence tomography.

### BACKGROUND

In many applications, imaging can be used to garner information about a particular object; particularly aspects about its surface or subsurface. One such imaging technique is tomography. A device practicing tomography images an object by sections or sectioning, through the use of a penetrating wave. Conventionally, tomography can be used for various applications; for example, radiology, biology, materials science, manufacturing, or the like. Some types of tomography include, for example, optical coherence tomography, x-ray tomography, positron emission tomography, optical projection tomography, or the like.

Conventionally, the above types of tomography, and especially optical coherence tomography, produce detailed imaging; however, such imaging can elicit a lot of data which can make feature extraction difficult and laborious.

### SUMMARY

In an aspect, there is provided a method for analysis of interferometric domain optical coherence tomography (OCT) of an object, the method executed on one or more processors, the method comprising: receiving the OCT data comprising one or more A-scans over an interferometric domain; successively analyzing each of the one or more A-scans, using a trained feed-forward neural network, to detect one or more features associated with the object by associating A-scan raw data with a descriptor for each of the one or more features, the feed-forward neural network trained using previous A-scans with one or more known features; generating location data associated with the one or more features for localizing the one or more features in the one or more A-scans; and outputting the feature detection and the location data.

In a particular case, analyzing each of the one or more A-scans to detect the one or more features comprises determining a class label indicating either a presence of one or more defects with the object or absence of defects with the object, the location data comprising a location of each of the defects.

In another case, the class label comprises a probability for the presence of each of the one or more defects.

In yet another case, the class label comprises at least one of a size, an area, or a volume of each of the defects.

In yet another case, the location data comprises a location along the surface of the object.

In yet another case, the location data comprises a depth location relative to the surface of the object.

In yet another case, the location data comprises time information associated with the respective A-scan.

In yet another case, the trained neural network comprises a trained Long-Term Short Memory (LSTM) machine learning model.

In yet another case, the trained neural network comprises a trained convolutional neural network (CNN) machine learning model

In yet another case, the method further comprising aggregating the one or more A-scans into a B-scan.

In yet another case, the method further comprising determining whether each of the one or more features traverse adjacent A-scans.

In another aspect, there is provided a system for analysis of interferometric domain optical coherence tomography (OCT) data of an object from an OCT system, the system for analysis of interferometric domain OCT data comprising one or more processors and a data storage device, the one or more processors configured to execute: a data science module to receive the OCT data comprising one or more A-scans over an interferometric domain and to successively analyze each of the one or more A-scans, using a trained feed-forward neural network, to detect one or more features associated with the object by associating A-scan raw data with a descriptor for each of the one or more features, the feed-forward neural network trained using previous A-scans with one or more known features; an interpretation module to generate location data associated with the one or more features for localizing the one or more features in the one or more A-scans; and an output interface to output the feature detection and the location data.

In a particular case, the data science module analyzes each of the one or more A-scans to detect the one or more features by determining a class label indicating either a presence of one or more defects with the object or absence of defects with the object, the location data comprising a location of each of the defects.

In another case, the class label comprises a probability for the presence of each of the one or more defects.

In yet another case, the class label comprises at least one of a size, an area, or a volume of each of the defects.

In yet another case, the location data comprises time or spatial information associated with the respective A-scan.

In yet another case, the trained neural network comprises a trained Long-Term Short Memory (LSTM) machine learning model.

In yet another case, the trained neural network comprises a trained convolutional neural network (CNN) machine learning model

In yet another case, the interpretation module aggregates the one or more A-scans into a B-scan.

In yet another case, the interpretation module determines whether each of the one or more features traverse adjacent A-scans.

These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is schematic diagram of an interferometric domain optical coherence tomography (OCT) system, according to an embodiment;

FIG. 2 is a schematic diagram for a neural network system for interferometric domain OCT, according to an embodiment;

FIG. 3 is a flowchart for a method for implementation of the neural network system for interferometric domain OCT, according to an embodiment;

FIG. 4 is an exemplary image captured to form a top-level surface view of an object;

FIG. 5A is an exemplary B-scan of an object without problematic defects or features;

FIG. 5B is an exemplary A-scan of the object of FIG. 5A;

FIG. 6 is an exemplary B-scan of an object with problematic defects or features;

FIG. 7 is an exemplary B-scan of an object for determining whether there are defects;

FIG. 8 is an exemplary B-scan of an object showing a defect;

FIGS. 9A and 9B are exemplary C-scans, at respectively different angles of perspective, of a vehicle part;

FIG. 10A is an exemplary B-scan in which a defect was detected in a paint layer of a vehicle part;

FIG. 10B is a plot of a score for the exemplary B-scan of FIG. 10A;

FIG. 11A is an exemplary B-scan, in which the system of FIG. 2 determined there are no features present;

FIG. 11B is an exemplary B-scan, in which the system of FIG. 2 determined there are features present; and

FIG. 12 is diagram of a memory cell.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to imaging interpretation and more specifically to an interferometric domain neural network system for non-destructive optical coherence tomography.

Optical coherence tomography (OCT), and particularly non-destructive OCT, is a technique for imaging in two or three-dimensions. OCT can provide a relatively high resolution, potentially up to few micrometers, and can have relatively deep penetration, potentially up to a few millimeters, in a scattering media.

OCT techniques can use back-scattered light from an object to generate information about that object; for example, generating a three-dimensional representation of that object when different regions of the object are imaged.

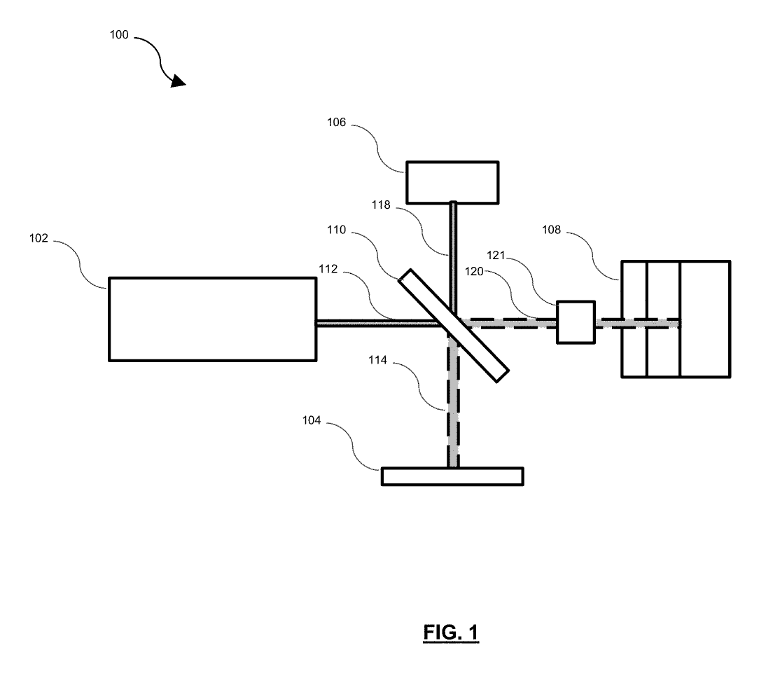

FIG. 1 illustrates a schematic diagram of an exemplary OCT system 100, according to an embodiment. The OCT system 100 includes an optical source 102, a reflective element 104 (for example, a mirror), a beam splitter 110, and a detector 106. The diagram shows an object 108 with three layers of depth. The optical source 102 produces an originating optical beam 112 that is directed towards the beam splitter 110. The beam splitter 110 divides the originating beam 112 and directs one derivative beam 114 towards the reflective element 104 and another derivative beam, referred to herein as the sample beam 120, towards the object to be scanned 108. Both derivative beams 114, 120 are directed back to the beam splitter 110, and then directed as a resultant beam 118 to the detector 106. In some cases, one or more secondary mirrors (not shown) can be provided to reflect the sample beam 120 onto the object 108; particularly in circumstances where the object 108 cannot be physically placed in the line of sight of the sample beam 120 due to physical constraints.

In some cases, the system 100 can include a scanner head 121 to direct the sample beam 120 onto the object 108. In some cases, the scanner head 121 can include a beam steering device to direct light to the object 108. The beam steering device may be, for example, a mirror galvanometer in one or two dimensions, a single axis scanner, a microelectromechanical system (MEMs)-based scanning mechanism, a rotating scanner, or other suitable mechanism for beam steering. The beam steering device may be controlled electromechanically. In some embodiments, the scanner head 121 can include a focal-length adjusting mechanism, such as a tuneable lens or a translatable scanner head 121.

OCT systems 100 generally use different localization techniques to obtain information in the axial direction, along the axis of the originating optical beam 112 (z-axis), and obtain information in the transverse direction, along a plane perpendicular to the axis of the originating beam 112 (x-y axes). Information gained from the axial direction can be determined by estimating the time delay of the optical beam reflected from structures or layers associated with the object 108. OCT systems 100 can indirectly measure the time delay of the optical beam using low-coherence interferometry.

Typically OCT systems that employ low-coherence interferometers can use an optical source 102 that produces an optical beam 112 with a broad optical bandwidth. The originating optical beam 112 coming out of the source 102 can be split by the beam splitter 110 into two derivative beams (or paths). The first derivative beam 114 can be referred to as the reference beam (or arm) and the second derivative beam 120 can be referred to as the sample beam (or arm) of the interferometer. Each derivative beam 114, 120 is reflected back and combined at the detector 106.

The detector 106 can detect an interference effect (fast modulations in intensity) if the time travelled by each derivative beam in the reference arm and sample arm are approximately equal; whereby “equal” generally means a difference of less than a ‘coherence length.’ Thus, the presence of interference serves as a relative measure of distance travelled by light.

For OCT, the reference arm can be scanned in a controlled manner, and the reference beam 114 can be recorded at the detector 106. An interference pattern can be detected when the mirror 104 is nearly equidistant to one of the reflecting structures or layers associated with the object 108. The detected distance between two locations where the interference occurs corresponds to the optical distance between two reflecting structures or layers of the object in the path of the beam. Advantageously, even though the optical beam can pass through different structures or layers in the object, OCT can be used to separate out the amount of reflections from individual structures or layers in the path of the optical beam.

With respect to obtaining information in the transverse direction, the originating beam 112 can be focused on a small area of the object 108, potentially on the order of a few microns, and scanned over a region of the object.

In another embodiment of an OCT system, Fourier-domain can be used as a potentially efficient approach for implementation of low-coherence interferometry. Instead of recording intensity at different locations of the reference reflective element 104, intensity can be detected as a function of wavelengths or frequencies of the optical beam 112. In this case, intensity modulations, as a function of frequency, are referred to as spectral interference. Whereby, a rate of variation of intensity over different frequencies can be indicative of a location of the different reflecting structures or layers associated with the object. A Fourier transform of spectral interference information can then be used to provide information similar to information obtained from moving the optical beam, as described above.

In an embodiment of an OCT system, spectral interference can be obtained using either, or both, of spectral-domain techniques and swept-source techniques. With the spectral-domain technique, the optical beam can be split into different wavelengths and detected by the detector 106 using spectrometry. In the swept-source technique, the optical beam produced by the optical source 102 can sweep through a range of optical wavelengths, with a temporal output of the detector 106 being converted to spectral interference.

Advantageously, employing Fourier-domain can allow for faster imaging because back reflections from the object can be measured simultaneously.

The resolution of the axial and transverse information can be considered independent. Axial resolution is generally related to the bandwidth, or the coherence-length, of the originating beam 112. In the case of a Gaussian spectrum, the axial resolution (Δz) can be: Δz=0.44*λ₀²/Δλ, where λ₀ is the central wavelength of the optical beam and Δλ is the bandwidth defined as full-width-half-maximum of the originating beam. In other cases, for spectrum of arbitrary shape, the axial spread function can be estimated as required.

In some cases, the depth of the topography imaging for an OCT system is typically limited by the depth of penetration of the optical beam into the object 108, and in some cases, by the finite number of pixels and optical resolution of the spectrometer associated with the detector 106. Generally, total length or maximum imaging depth zₘₐₓ is determined by the full spectral bandwidth λ_{full} of the spectrometer and is expressed by zₘₐₓ=(¼N)*(λ₀²/λ_{full}) where N is the total number of pixels of the spectrometer.

With OCT systems, sensitivity is generally dependent on the distance, and thus delay, of reflection. Sensitivity is generally related to depth by: R(z)=sin(p*z)/(p*z)*exp(−z²/(w*p)). Where w depends on the optical resolution of spectrometer associated with the detector 106. The first term related to the finite pixels in the spectrometer and the second term related to the finite optical resolution of the spectrometer.

When implementing the OCT system 100, reflected sample and reference optical beams that are outside of the coherence length will theoretically not interfere. This reflectivity profile, called an A-scan, contains information about the spatial dimensions, layers and location of structures within the object 108 of varying axial-depths; where the ‘axial’ direction is along the axis of the optical beam path. A cross-sectional tomograph, called a B-scan, may be achieved by laterally combining a series of adjacent A-scans along an axis orthogonal to the axial direction. A B-scan can be considered a slice of the volume being imaged. One can then further combine a series of adjacent B-scans to form a volume which is called a C-scan. Once an imaging volume has been so composed, a tomograph, or slice, can be computed along any arbitrary plane in the volume

A-scans represent an intensity profile of the object, and its values (or profile) characterize reflectance of the way the optical beam penetrates the surface of the object. Thus, such scans can be used to characterize the material from the surface of the object to some depth, at an approximately single region of the object 108. B-scans can be used to provide material characterization from the surface of the object 108 to some depth, across a contour on the surface of the object 108.

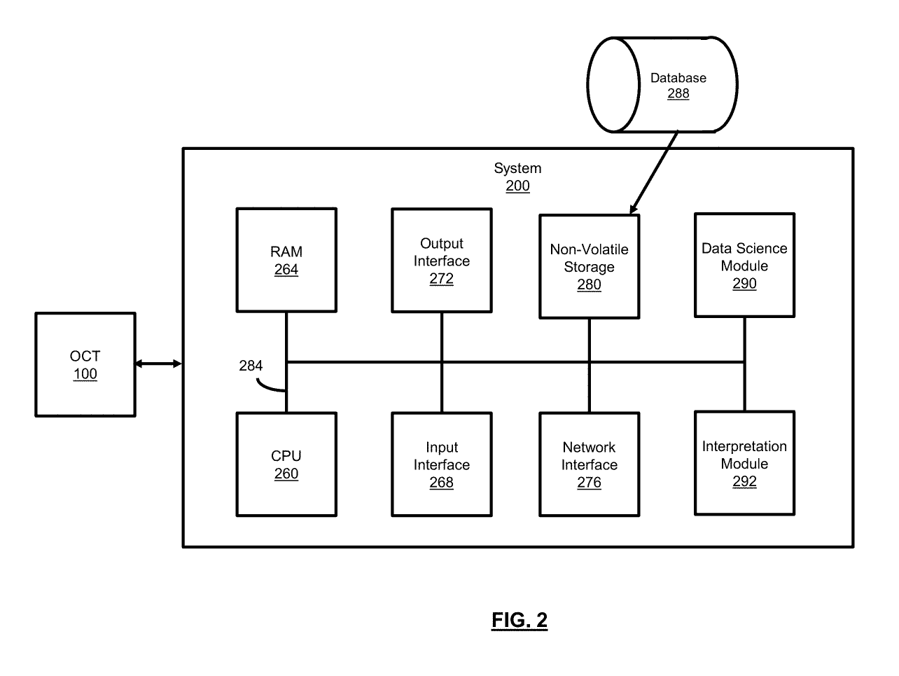

As shown in FIG. 2, a schematic diagram for an interferometric domain neural network system 200 for non-destructive OCT, according to an embodiment, is shown. As shown, the system 200 has a number of physical and logical components, including a central processing unit (“CPU”) 260, random access memory (“RAM”) 264, an input interface 268, an output interface 272, a network interface 276, non-volatile storage 280, and a local bus 284 enabling CPU 260 to communicate with the other components. CPU 260 can include one or more processors. RAM 264 provides relatively responsive volatile storage to CPU 260. The input interface 268 enables an administrator to provide input via a keyboard and mouse. The output interface 272 outputs information to output devices, such as a display and/or speakers. The network interface 276 permits communication with other systems or computing devices. Non-volatile storage 280 stores the operating system and programs, including computer-executable instructions for implementing the OCT system 100 or analyzing data from the OCT system 100, as well as any derivative or related data. In some cases, this data can be stored in a database 288. During operation of the system 200, the operating system, the programs and the data may be retrieved from the non-volatile storage 280 and placed in RAM 264 to facilitate execution. In an embodiment, the CPU 260 can be configured to execute a data science module 290 and an interpretation module 292.

In some cases, some or all of the interferometric domain neural network system 200 can be located in or associated with the scanner head 121; as an example, the data science module 290 and/or the interpretation module 292 being located in the scanner head 121. In some cases, this can include another CPU 260 and RAM 264 located in the scanner head 121.

In the present embodiment, the system 200 can be used to detect features associated with the surface and subsurface of an object; and in some cases, categorize such features. In a particular case, such features are defects in the object, due to, for example, various manufacturing-related errors or conditions. In such an example, the system 200 can be used for quality-checking or quality-assurance operations.

The data science module 290 can use machine learning (ML) to transform raw data from the A-scan, B-scan, or C-scan into a descriptor. The descriptor is information associated with a particular defect in the object. The descriptor can then be used by the interpretation module 292 to determine a classifier for the defect. As an example, the data science module 290 can do this detection and classification with auto-encoders as part of a deep belief network. In this sense, ML can be used as part of feature descriptor extraction process, otherwise called “feature learning.” In some cases, the data science module 290 can perform the machine learning remotely over a network to an OCT system located elsewhere. The auto-encoder can be trained to learn to reconstruct a representation of the input descriptor to a particular or arbitrary precision; similar to managing quantization error or approximation error of a time series with a set of Fourier/wavelet coefficients.

In further embodiments, instead of, or along with, “feature learning”, “feature engineering” can also be undertaken by the data science module 290 to determine appropriate values for discrimination of distinct classes in the OCT data. The data science module 290 can then use ML to provide a posterior probability distribution for class assignment of the object to the class labels. In some cases, “feature engineering” can include input from a user such as a data scientist or computer vision engineer.

In an embodiment, the interpretation module 292 can provide class labels of either “acceptable” or “defective”, which it can then provide to the output interface 272. The acceptable label indicates that the object is without defect, or that the number of defects is within an acceptable range in the context of quality control (QC). The defective label indicates that an unacceptable defect has been detected, and in some cases, such defect is of a particular type. In an example, such as where the object is a vehicle part, the defect may have different shapes and dimensions. As an example, the defect may be an unwanted round seed or crater, or the like, on or under the surface of the part. As another example, the defect may have an elongated shape, such as with an unwanted fiber, or the like, on or under the surface of the part. As an example, the acceptable/defective label may be with regards to the size, area, or volume of a defect. In another example, acceptable/defective label may be with regards to the presence of defect between different layers of films applied in an industrial process; for example, in an automotive setting, in an electro-deposition (ED) layer, a colour layer, or a clear layer, where each layer is in the order of tens of microns thick.

In some cases, the interpretation module 292, based on the data science module 290 analysis of the OCT images, can provide further information in the form of feature localization on the object. As an example, the information may be that there is fiber defect at location x=3.4 cm, y=5.6 cm on a vehicle part. Feature localization can also be specified with respect to surface depth, along the z-axis. Depth localization can be particularly advantageous in certain applications; for example, when thin films are being applied to a vehicle part. In this case, for example, after a vehicle part is painted, paint inspection may be required on various layers including an electro-deposition layer, a colour layer, and a clear coat layer. Being able to detect and determine the presence of a defect between any two of these layers is particularly advantageous because it has implications on the amount of re-work that may be required to resolve the imperfection. It can also be advantageous for improvement to a manufacturing process by being able to determine what type of defect is located at what layer; for example, a faulty HVAC system in the manufacturing environment could be responsible for introducing defects between layers. In this regard, being able to localize defect origin to a portion of the manufacturing path is an advantage to reduce future defects and rework.

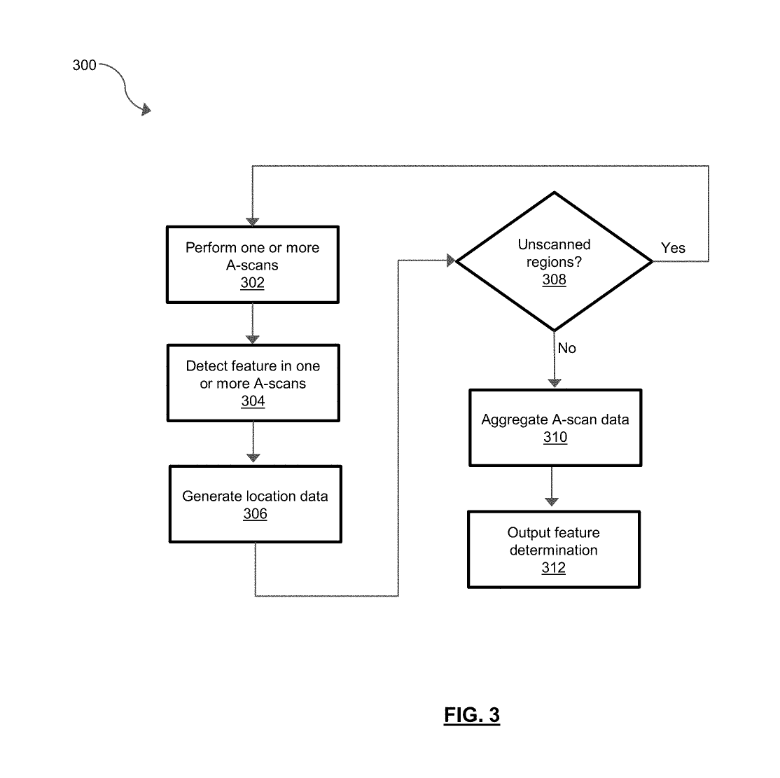

Turning to FIG. 3, a method 300 for implementation of the neural network system 200 for interferometric domain OCT, according to an embodiment, is shown. At block 302, the OCT system 100 performs one or more A-scans, and receives associated A-scan data, associated with an interferometric domain. As described above, the A-scan data from each A-scan is received by taking interferometric measurements of the object. In some embodiments, the scan data can be done beforehand and received by the system 200 in bulk.

At block 304, each of the one or more A-scans are successively analysed by the data science module 290 with a trained Long-Term Short Memory (LSTM) machine learning model in order to detect a feature associated with the object, such as a defect. For each A-scan, the interpretation module 292 can produce a number between 0 to 1 which indicates the probability of the A-scan being defective, with 0 being representative for defective and 1 being representative of non-defective. In further cases, other scoring or numbering schemes can be used.

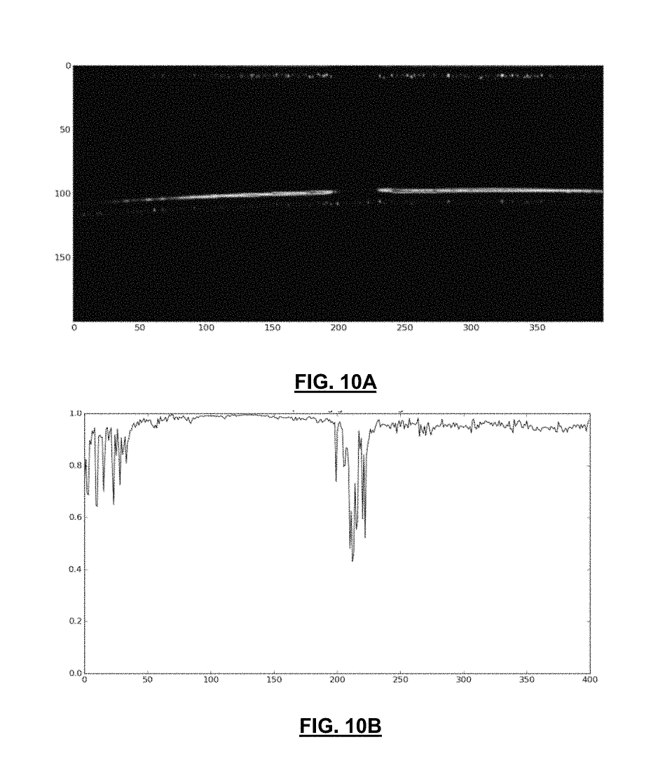

As an example, FIG. 10A illustrates a B-scan in which a defect was detected in a paint layer of a vehicle part. As shown, the defect is centered at approximately 225×10⁻² mm along the fast scan axis (x-axis). Correspondingly, FIG. 10B illustrates a plot of a score produced by the interpretation module 292, between 0 and 1, representing a determined possibility that a defect is present in the exemplary B-scan of FIG. 10A.

At block 306, the interpretation module 292 generates and stores location data associated with the feature associated with the object; such as the location of a defect. As an example, the location data can include time or spatial information associated or embedded with the one or more A-scans. Such time information can be used by the system 200 for localizing the defect due to knowing when the one or more A-Scans associated with the interferometric domain were taken in a larger series of A-scans associated with more interferometric domains. In some cases, the location data can be metadata associated with the respective A-scan data.

At block 308, the CPU 260 determines whether there are unscanned regions (or interferometric domains) of the object to be scanned that have not had A-scans. If there are unscanned regions, the system 200 repeats blocks 302 to 306. Otherwise, at block 310, in some cases, the interpretation module 292 aggregates the A-scan data into one or more B-scans comprising B-scan data. In further cases, the interpretation module 292 also aggregates the B-scan data into one or more C-scans comprising C-scan data. The aggregated data includes the location data associated with the A-scans.

At 312, the system 200 outputs the feature determination, including the location data, via the output interface 272. The feature determination can be outputted in any suitable format; for example, images, graphs, alerts, textual information, or the like. In further embodiments, the determinations can be provided to other systems or machinery. In further embodiments, the feature determination can be outputted after it is determined, not necessarily requiring aggregation into a B-scan or C-scan.

In some cases, the interpretation module 292 can use the location data of the A-scans to locate the feature associated with the object in the respective B-scan and/or the respective C-scan. In some cases, where the A-scan, B-scan, and/or C-scan are presented to a user as an image via the output interface 272, the location data can be used to present the location of the feature in the image.

In some cases, the interpretation module 292 can determine whether the feature is a single feature traversing adjacent A-scans or represents two discrete features, one in each A-scan. The contours of the feature in a single A-scan, or in adjacent A-scans, can be detected by the data science module 290 by segmenting the one or more A-scans. The segmentation to determine contours or thresholds can use, for example, Canny edge detection, Otsu clustering-based image thresholding, Integral Image Thresholding such as the Bradley-Roth adaptive thresholding, or the like. Then based on the continuity of the determined contours and/or thresholds, the data science module 290 can use the trained Long-Term Short Memory (LSTM) machine learning model in order to detect a feature associated with the object, such as a defect.

As an intended substantial advantage of method 300, decomposition of tomographic image formation, such as B-scans and C-scans, may not be required to detect a feature of the object. This is advantageous because it can, for example: allow for easier location of such features; allow for delayed tomographic image formation; and allow for tomographic image formation of only areas with features, thus saving computing resources. As another intended advantage, the A-scan feature detection can be accomplished by components of the scanner head 121, which may allow for greater modularity and efficiency of the system 100.

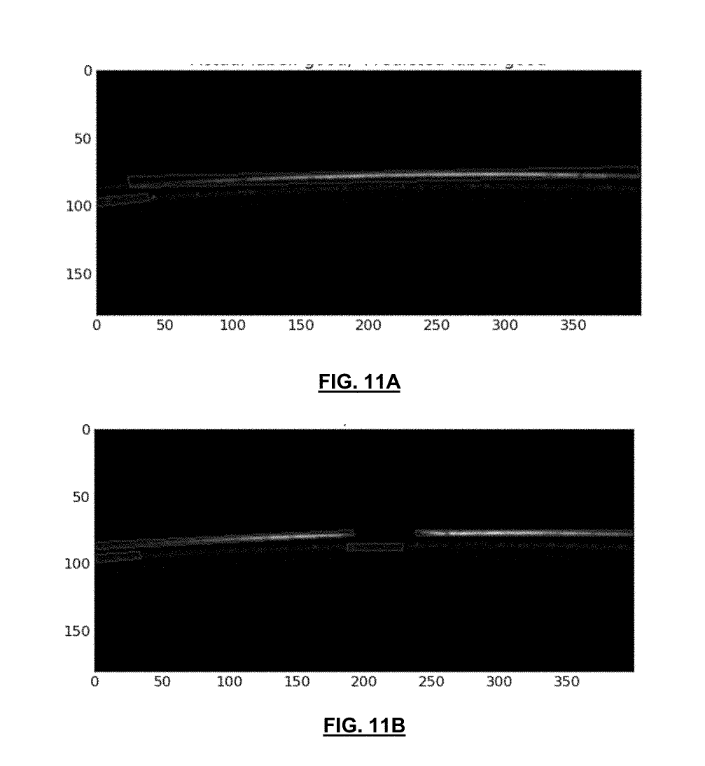

As an example, FIG. 11A illustrates a B-scan in which contours are outlined. In this case, the data science module 290 examining the location data from A-scans determined that there was no defect detected on the object. FIG. 11B also illustrates a B-scan in which contours are outlined. In this case, the data science module 290 examining the location data from A-scans determined that there was a defect detected on the object. The interpretation module 292 can then determine the coordinates and size of the feature. Based on the location data, the interpretation module 292 determined that this defect occurs between approximately 175 and 240 along the x-axis.

The machine-learning based analysis of the data science module 290 may be implemented by providing input data to the neural network, such as a feed-forward neural network, for generating at least one output. The neural networks described herein may have a plurality of processing nodes, including a multi-variable input layer having a plurality of input nodes, at least one hidden layer of nodes, and an output layer having at least one output node. During operation of a neural network, each of the nodes in the hidden layer applies a function and a weight to any input arriving at that node (from the input layer or from another layer of the hidden layer), and the node may provide an output to other nodes (of the hidden layer or to the output layer). The neural network may be configured to perform a regression analysis providing a continuous output, or a classification analysis to classify data. The neural networks may be trained using supervised or unsupervised learning techniques, as described above. According to a supervised learning technique, a training dataset is provided at the input layer in conjunction with a set of known output values at the output layer. During a training stage, the neural network may process the training dataset; for example, using previous A-scans, B-scans, or C-scans with one or more known features. It is intended that the neural network learn how to provide an output for new input data by generalizing the information it learns in the training stage from the training data. Training may be affected by backpropagating error to determine weights of the nodes of the hidden layers to minimize the error. The training dataset, and the other data described herein, can be stored in the database 288 or otherwise accessible to the system 200. Once trained, or optionally during training, test data can be provided to the neural network to provide an output. A neural network may thus cross-correlate inputs provided to the input layer in order to provide at least one output at the output layer. Preferably, the output provided by a neural network in each embodiment will be close to a desired output for a given input, such that the neural network satisfactorily processes the input data.

In some cases, the training dataset can be imported in bulk from a historical database of OCT scans and labels, or feature determinations, associated with such scans.

In further cases, the system 200 can first operate in a ‘training mode’. In such training mode, OCT scans are acquired by the system 200. Feature engineering can be manually determined, or determined automatically with manual oversight, and can include various techniques, for example: shape detection or characterization; pixel intensity determinations such as histogram equalization or the like; feature extraction such as mathematical morphology, local binary patterns, wavelets, thresholding, or the like; or pre-processing such as bilateral filtering, edge preserving smoothing, total variation filtering, or the like. A combination of the above feature engineering techniques may be used.

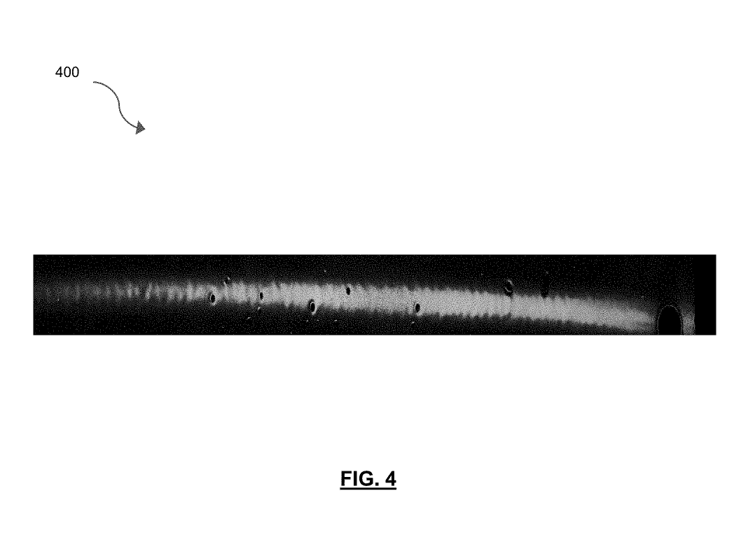

FIG. 4 illustrates an exemplary image 400 captured to form a top-level surface view of an object.

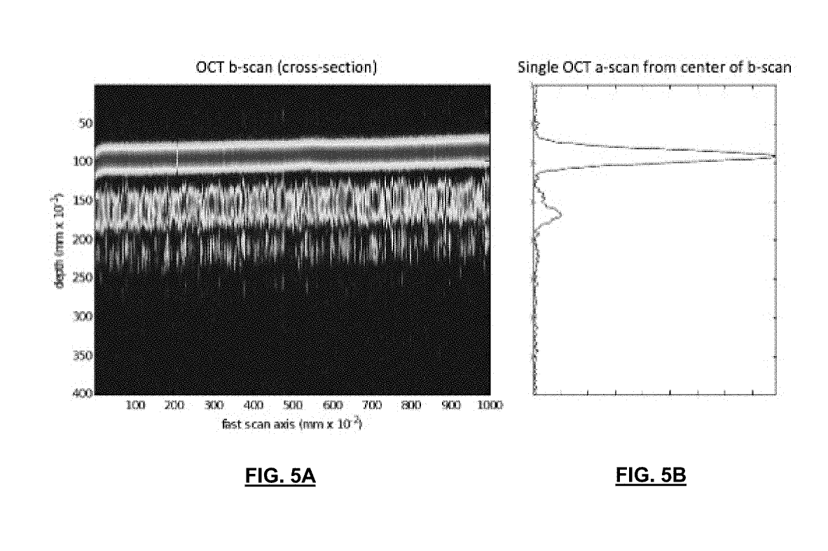

FIG. 5A illustrates an exemplary B-scan (cross-section) of an object without problematic defects or features (i.e., a ‘clean’ surface). FIG. 5A illustrates an exemplary A-scan from the center of the B-scan.

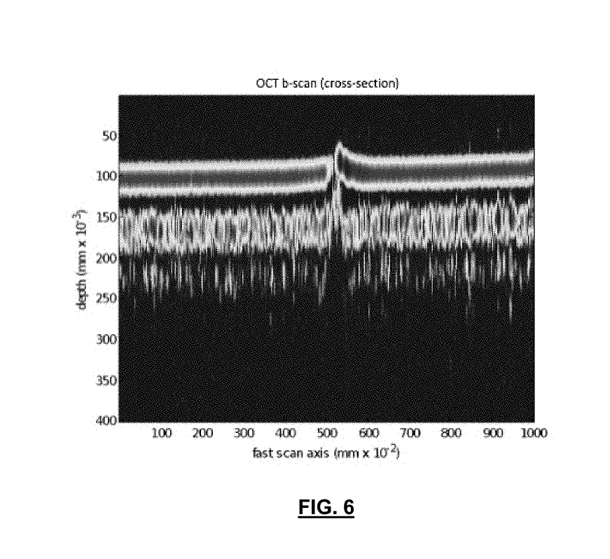

FIG. 6 illustrates an exemplary B-scan (cross-section) of an object with a problematic defect or feature present. In this case, as shown, there was a subsurface seed detected, centered at approximately 500 along the x-axis.

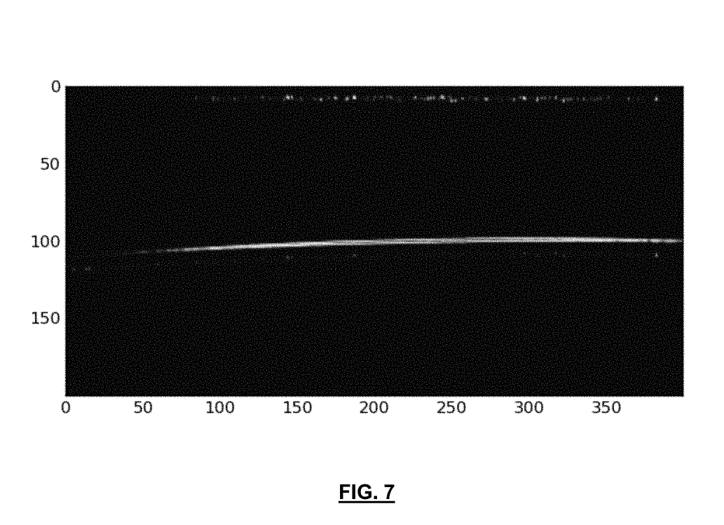

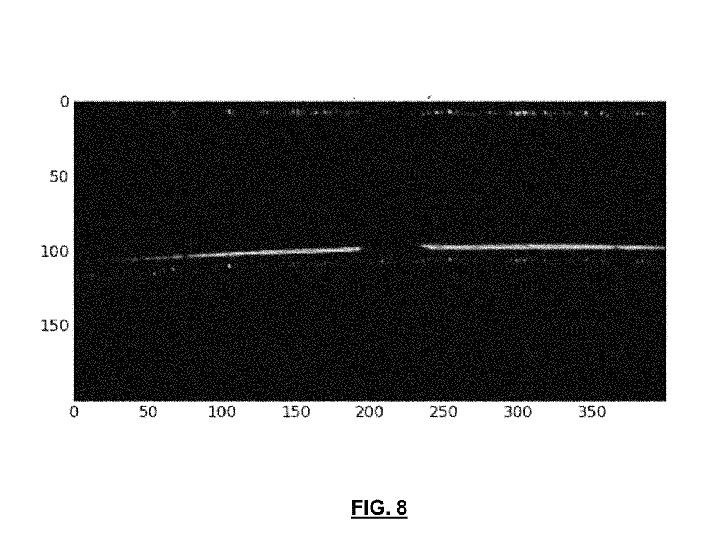

FIG. 7 illustrates an exemplary B-scan of a vehicle part for determining whether there are painting defects. In this case, there was no defect from the B-scan. FIG. 8 illustrates an exemplary B-scan of a vehicle part for determining whether there are painting defects. In this case, as shown, there was a defect in the paint layer detected, centered at approximately 225 along the x-axis.

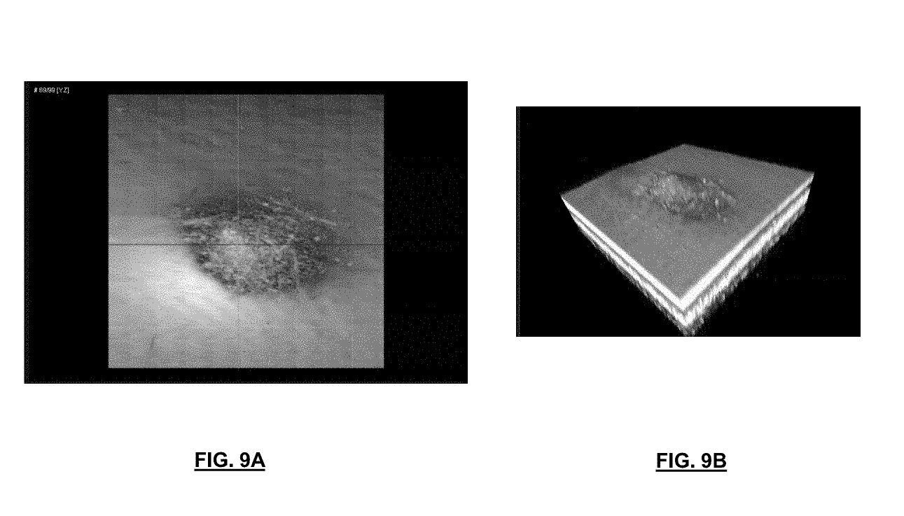

FIGS. 9A and 9B illustrate, at respectively different angles of perspective, an exemplary C-scan of a vehicle part. In this case, a seed was detected as a defect in the painting of a vehicle part.

In embodiments described herein, the data science module 290 can perform the detection by employing, at least in part, an LSTM machine learning approach. The LSTM neural network allows the system 200 to quickly and efficiently perform group feature selections and classifications.

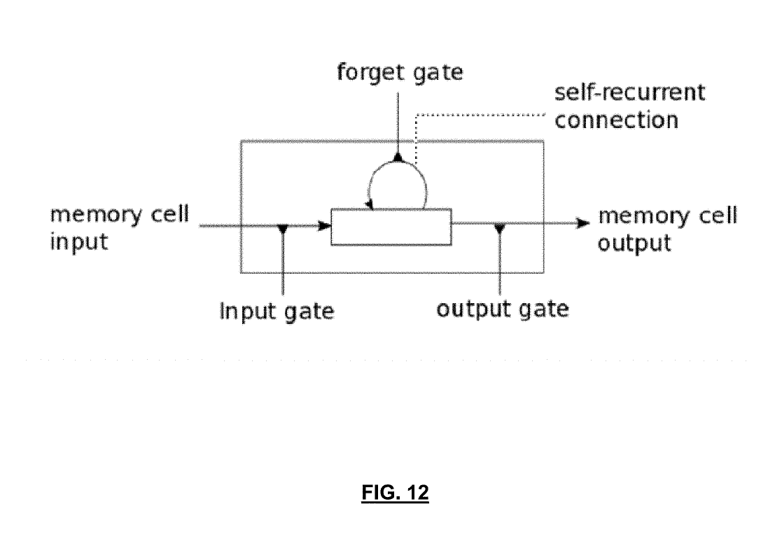

The LSTM neural network is a category of neural network model specified for sequential data analysis and prediction. The LSTM neural network comprises at least three layers of cells. The first layer is an input layer, which accepts the input data. The second (and perhaps additional) layer is a hidden layer, which is composed of memory cells (see FIG. 12). The final layer is output layer, which generates the output value based on the hidden layer using Logistic Regression.

Each memory cell, as illustrated, comprises four main elements: an input gate, a neuron with a self-recurrent connection (a connection to itself), a forget gate and an output gate. The self-recurrent connection has a weight of 1.0 and ensures that, barring any outside interference, the state of a memory cell can remain constant from one time step to another. The gates serve to modulate the interactions between the memory cell itself and its environment. The input gate permits or prevents an incoming signal to alter the state of the memory cell. On the other hand, the output gate can permit or prevent the state of the memory cell to have an effect on other neurons. Finally, the forget gate can modulate the memory cell's self-recurrent connection, permitting the cell to remember or forget its previous state, as needed.

Layers of the memory cells can be updated at every time step, based on an input array (the OCT scan data). Using weight matrices and bias vectors, the values at the input gate of the memory cell and the candidate values for the states of the memory cells at the time step can be determined. Then, the value for activation of the memory cells' forget gates at the time step can be determined. Given the value of the input gate activation, the forget gate activation and the candidate state value, the memory cells' new state at the time step can be determined. With the new state of the memory cells, the value of their output gates can be determined and, subsequently, their outputs.

Based on the model of memory cells, at each time step, the output of the memory cells can be determined. Thus, from an input sequence, the memory cells in the LSTM layer will produce a representation sequence for their output. Generally, the goal is to classify the sequence into different conditions. The Logistic Regression output layer generates the probability of each condition based on the representation sequence from the LSTM hidden layer. The vector of the probabilities at a particular time step can be determined based on a weight matrix from the hidden layer to the output layer, and a bias vector of the output layer. The condition with the maximum accumulated probability will be the predicted outcome of this sequence.

In embodiments described herein, the data science module 290 can perform the detection by employing, at least in part, a convolutional neural network (CNN) machine learning approach.

CNN machine learning models are generally a neural network that is comprised of neurons that have learnable weights and biases. In a particular case, CNN models are beneficial when directed to extracting information from images. Due to the specificity of being directed to images, CNN models are advantageous because such models allow for a forward function that is more efficient to implement and reduces the amount of parameters in the network. Accordingly, the layers of a CNN model generally have three-dimensions of neurons called width, height, and depth; whereby depth refers to an activation volume. The capacity of CNN models can be controlled by varying their depth and breadth, such that they can make strong and relatively correct assumptions about the nature of images, such as stationarity of statistics and locality of pixel dependencies.

Typically, the input for the CNN model includes the raw pixel values of the input images. A convolutional layer is used to determine the output of neurons that are connected to local regions in the input. Each layer uses a dot product between their weights and a small region they are connected to in the input volume. A rectified linear units layer applies an element by element activation function, f(x)=max(0, x), to all of the values in the input volume. This layer increases the nonlinear properties of the model and the overall network without affecting the receptive fields of the convolutional layer. A pooling layer performs a down-sampling operation along the spatial dimensions. This layer applies a filter to the input volume and determines the maximum number in every subregion that the filter convolves around. As typically of a neural network, each output of a neuron is connected to other neurons with back-propagation.

While the method 300 and system 200 are described as using certain machine-learning approaches, specifically LSTM and CNN, it is appreciated that, in some cases, other suitable machine learning approaches may be used where appropriate.

In further embodiments, machine learning can also be used by the data science module 290 to detect and compensate for data acquisition errors at the A-scan, B-scan and/or C-scan levels.

While the above-described embodiments are primarily directed to detecting defects, those skilled in the art will appreciate that the same approach can be used for detecting other features of objects and used in various applications of OCT.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A method for analysis of interferometric domain optical coherence tomography (OCT) of an object, the method executed on one or more processors, the method comprising:
receiving the OCT data comprising one or more A-scans over an interferometric domain;
successively analyzing each of the one or more A-scans, using a trained feed-forward neural network, to detect one or more features associated with the object by associating A-scan raw data with a descriptor for each of the one or more features, the feed-forward neural network trained using previous A-scans with one or more known features;
generating location data associated with the one or more features for localizing the one or more features in the one or more A-scans; and
outputting the feature detection and the location data.

2. The method of claim 1, wherein analyzing each of the one or more A-scans to detect the one or more features comprises determining a class label indicating either a presence of one or more defects with the object or absence of defects with the object, the location data comprising a location of each of the defects.

3. The method of claim 2, wherein the class label comprises a probability for the presence of each of the one or more defects.

4. The method of claim 2, wherein the class label comprises at least one of a size, an area, or a volume of each of the defects.

5. The method of claim 1, wherein the location data comprises a location along the surface of the object.

6. The method of claim 5, wherein the location data comprises a depth location relative to the surface of the object.

7. The method of claim 1, wherein the location data comprises time information associated with the respective A-scan.

8. The method of claim 1, wherein the trained neural network comprises a trained Long-Term Short Memory (LSTM) machine learning model.

9. The method of claim 1, wherein the trained neural network comprises a trained convolutional neural network (CNN) machine learning model

10. The method of claim 1, further comprising aggregating the one or more A-scans into a B-scan.

11. The method of claim 10, further comprising determining whether each of the one or more features traverse adjacent A-scans.

12. A system for analysis of interferometric domain optical coherence tomography (OCT) data of an object from an OCT system, the system for analysis of interferometric domain OCT data comprising one or more processors and a data storage device, the one or more processors configured to execute:
a data science module to receive the OCT data comprising one or more A-scans over an interferometric domain and to successively analyze each of the one or more A-scans, using a trained feed-forward neural network, to detect one or more features associated with the object by associating A-scan raw data with a descriptor for each of the one or more features, the feed-forward neural network trained using previous A-scans with one or more known features;
an interpretation module to generate location data associated with the one or more features for localizing the one or more features in the one or more A-scans; and
an output interface to output the feature detection and the location data.

13. The system of claim 12, wherein the data science module analyzes each of the one or more A-scans to detect the one or more features by determining a class label indicating either a presence of one or more defects with the object or absence of defects with the object, the location data comprising a location of each of the defects.

14. The system of claim 13, wherein the class label comprises a probability for the presence of each of the one or more defects.

15. The system of claim 13, wherein the class label comprises at least one of a size, an area, or a volume of each of the defects.

16. The system of claim 12, wherein the location data comprises time or spatial information associated with the respective A-scan.

17. The system of claim 12, wherein the trained neural network comprises a trained Long-Term Short Memory (LSTM) machine learning model.

18. The system of claim 12, wherein the trained neural network comprises a trained convolutional neural network (CNN) machine learning model

19. The system of claim 12, wherein the interpretation module aggregates the one or more A-scans into a B-scan.

20. The system of claim 19, wherein the interpretation module determines whether each of the one or more features traverse adjacent A-scans.
